(19) United States
(12) Patent Application Publication
(10) Pub. No.: US 2021/0272076 A1
(43) Pub. Date: Sep. 2, 2021

(54) METHOD AND SYSTEM FOR CHARGING COPYRIGHT ROYALTY AND ALLOCATING PROFIT ON BASIS OF DOMAIN-DIGITAL ASSET LINKAGE

(71) Applicant: Chung Jong LEE, Gangwon-do (KR)

(72) Inventor: Chung Jong LEE, Gangwon-do (KR)

(21) Appl. No.: 17/261,762

(22) PCT Filed: Jul. 23, 2019
(86) PCT No.: PCT/KR2019/009091

§ 371 Date: Jan. 20, 2021

(30) Foreign Application Priority Data
Jul. 24, 2018 (KR) 10-2018-0086264

(51) Int. Cl. G06Q 20/06; G06Q 20/36; G06Q 20/38; G06Q 30/04; G06Q 40/06

(52) U.S. Cl. CPC G06Q 20/065; G06Q 20/363; G06Q 40/06; G06Q 30/04; G06Q 20/3829

(57) ABSTRACT

A method for charging copyright royalty and allocating profits, by a registrar server, on the basis of domain-digital asset linkage includes: receiving, by the registrar server, a request for registration of a domain entity including a domain address and digital asset information from a client of a domain owner or a prospective owner; and sending, by the registrar server, a request for registration of all or part of the domain entity to a registry server, wherein the digital asset information is retention information on cryptocurrency in which transaction records of digital coins are encrypted and connected to a network of node servers and a blockchain structure, and the digital coins include copyright coins issued on the basis of a copyright, thereby achieving smooth charging of copyright royalty and allocation of profits using linked copyright coin issuance information according to domain-copyright coin linkage.

### BACKGROUND OF THE DISCLOSURE

### Field of the Disclosure

The present disclosure relates to a method and system for charging copyright royalty and allocating profits on the basis of domain-digital asset linkage, and particularly, to a method and system for charging copyright royalty and allocating profits on the basis of domain-digital asset linkage, which can verify assets through a domain name and perform charging for a copyright and profit allocation using copyright coin issuance information.

### Related Art

To access a website, a user uses a uniform resource locator (URL) or a domain name associated with the site. Domain names are limited resources on the Internet and a specific domain name can be occupied by one owner and used to operate a website.

A domain name can be occupied by registering domain entities such as the domain name, an owner, and a name server in a registry, and registration of domain entities is performed by requesting registration to a registrar that can register domain entities in the registry for a user.

An asset size of a website operated with a domain name can merely be estimated using indexes such as the number of visitors and awareness, and there are no means for actually determining an asset size of a website business model because a domain name can be registered at a relatively low cost.

Meanwhile, there are websites that officially announce the amount of issuance, the amount of circulation, and the like of cryptocurrency and digital coins based on the blockchain in which transaction records are distributed and maintained through a network of distributed nodes, but it is difficult to find a website operated by a subject of issuance of the cryptocurrency or digital coins and operation of a website of a subject of issuance is frequently interrupted due to management error or sudden increase in traffic. Although anyone can issue digital coins if he/she pays a cost, it is difficult to ascertain the website information and asset size of the corresponding digital coin issuance subject.

Meanwhile, transaction of individual works such as digital music sources is performed through the copyright association and intermediary sites (e.g., a digital music source transaction site). Accordingly, direct transaction between a seller who wants to directly sell a work and an original copyright holder who wants to provide the work is not made, and the copyright association takes over the rights to transact works and provides works to purchasers only through some specific intermediary sites. Accordingly, it is difficult to make transaction between an original copyright holder and a seller who wants to directly sell works, in general.

### SUMMARY

An object of the present disclosure devised to solve the aforementioned problems is to provide a method and system for charging copyright royalty and allocating profits on the basis of domain-digital asset linkage, which can officially announce an asset scale of an operator in comparison with the value of a website operated with a domain name, officially announce domain information and an asset size of a subject of issuance of cryptocurrency and digital coins, allow domain name ownership/website operation expenses to be paid using connected digital assets such that a website is stably operated, provide copyright coin issuance information such that charging for a copyright and profit allocation are smoothly performed, enable fund type copyright coin investment based on copyright coins, and allow direct transaction between an original copyright holder and a work seller.

According to various embodiments of the present disclosure, a method for charging copyright royalty and allocating profits, by a registrar server, on the basis of domain-digital asset linkage, may include: receiving, by the registrar server, a request for registration of a domain entity including a domain address and digital asset information from a client of a domain owner or a prospective owner; and sending, by the registrar server, a request for registration of all or part of the domain entity to a registry server, wherein the digital asset information is retention information on cryptocurrency in which transaction records of digital coins are encrypted and connected to a network having node servers and a blockchain structure, and the digital coins include copyright coins issued on the basis of a copyright.

According to various embodiments of the present disclosure, a system for charging copyright royalty and allocating profits on the basis of domain-digital asset linkage may include a registrar server connected to a registry server, a network having node servers and a blockchain structure in which transaction records of digital coins are encrypted, and a client of a domain owner or a prospective owner, wherein the registrar server receives a request for registration of a domain entity including a domain address and digital asset information from the client of the domain owner or the prospective owner and sends a request for registration of all or part of the domain entity to the registry server, the digital asset information is retention information on cryptocurrency in which transaction records of digital coins are encrypted and connected to the network having node servers and a blockchain structure, and the digital coins include copyright coins issued on the basis of a copyright.

### Advantageous Effects

As described above, the method and system for charging copyright royalty and allocating profits on the basis of domain-digital asset linkage according to the present disclosure can allow a financial state of a domain owner to be verified through official announcement of digital assets and enable a user to be able to determine whether the domain owner runs a business by providing digital asset possession information of the domain owner through official notice of a corresponding domain entity of a registrar or a registry even if operation of a website of the domain owner is temporarily interrupted.

In addition, since a domain is linked with digital assets, domain ownership and operation fees can be paid using the linked digital assets, and thus a fee for registration of extension term of the domain, traffic expense, and various domain based service expenses are paid within a digital asset range of the domain owner so that ownership and operation of the domain can be continuously maintained. Such expenses can be paid using the digital assets linked to the domain without additional payment information authentication.

Furthermore, since a domain is linked to copyright coins, charging for a copyright and profit allocation can be smoothly performed using issuance information of the linked copyright coins.

Moreover, monetization of copyright can be diversified by issuing fund type copyright coins.

Furthermore, as direct transaction between an original copyright holder and a seller is made, distribution of works can be activated and both the original copyright holder and the seller can make profits with respect to works.

### BRIEF DESCRIPTION OF THE DRAWINGS

FIG. 1 is a block diagram illustrating a method and system for charging copyright royalty and allocating profits on the basis of domain-digital asset linkage according to an embodiment of the present disclosure.

FIG. 2 is a flowchart illustrating a method for charging copyright royalty and allocating profits on the basis of domain-digital asset linkage according to an embodiment of the present disclosure.

FIG. 3 is a flowchart for describing a method for issuing copyright coins according to an embodiment of the present disclosure.

FIG. 4 is a flowchart for describing a method for issuing fund type copyright coins according to an embodiment of the present disclosure.

FIG. 5 is a flowchart for describing the method for charging copyright royalty and allocating profits on the basis of domain-digital asset linkage according to an embodiment of the present disclosure.

FIG. 6 is a flowchart for describing the method for charging copyright royalty and allocating profits on the basis of domain-digital asset linkage according to an embodiment of the present disclosure.

FIG. 7 is a flowchart for describing the method for charging copyright royalty and allocating profits on the basis of domain-digital asset linkage according to an embodiment of the present disclosure.

FIG. 8 is a flowchart for describing the method for charging copyright royalty and allocating profits on the basis of domain-digital asset linkage according to an embodiment of the present disclosure.

FIG. 9 is a flowchart for describing the method for charging copyright royalty and allocating profits on the basis of domain-digital asset linkage according to an embodiment of the present disclosure.

FIG. 10 is a flowchart for describing the method for charging copyright royalty and allocating profits on the basis of domain-digital asset linkage according to an embodiment of the present disclosure.

FIG. 11 is a flowchart for describing a method for charging copyright royalty and allocating profits among an intermediary core, a provider, and a seller according to an embodiment of the present disclosure.

FIG. 12 is a flowchart for describing a method for calculating a settlement amount of a provider according to an embodiment of the present disclosure.

FIG. 13 is a flowchart for describing a purchase limit of a seller according to a deposit of the seller and a total amount limit according to an embodiment of the present disclosure.

FIG. 14 is a flowchart for describing a payment limit of a purchaser according to a deposit of a seller and a reference amount according to an embodiment of the present disclosure.

FIG. 15 is a flowchart for describing an operation of an artificial intelligence server in the method for charging copyright royalty and allocating profits according to an embodiment of the present disclosure.

FIG. 16 is a block diagram illustrating a system for charging copyright royalty and allocating profits according to another embodiment of the present disclosure.

FIG. 17 is a block diagram illustrating a system for charging copyright royalty and allocating profits according to another embodiment of the present disclosure.

FIG. 18 is a block diagram illustrating a system for charging copyright royalty and allocating profits according to another embodiment of the present disclosure.

### DESCRIPTION OF EXEMPLARY EMBODIMENTS

According to an aspect of the present disclosure, there is provided a method for charging copyright royalty and allocating profits, by a registrar server, on the basis of domain-digital asset linkage, including: receiving, by the registrar server, a request for registration of a domain entity including a domain address and digital asset information from a client of a domain owner or a prospective owner; and sending, by the registrar server, a request for registration of all or part of the domain entity to a registry server, wherein the digital asset information is retention information on cryptocurrency in which transaction records of digital coins are encrypted and connected to a network having node servers and a blockchain structure, and the digital coins include copyright coins issued on the basis of a copyright.

Hereinafter, various embodiments of the present disclosure will be described with reference to the attached drawings. In addition, a detailed description of known functions or configurations incorporated herein will be omitted when it may obscure the subject matter of the present disclosure. The terms which will be described later are defined taking into consideration of functions of the present disclosure and may be changed depending on the intention or convention of users or operators. Accordingly, they should be defined on the basis of the overall content of this specification.

Preferred embodiments of a system for charging copyright royalty and allocating profits according to the present disclosure will be described with reference to the attached drawings. However, the present disclosure is not limited to the embodiments disclosed below and can be implemented in various different forms, and the present embodiment is provided to complete the disclosure of the present invention and to inform those skilled in the art of the scope of the invention.

Various embodiments of this specification may be implemented as software (e.g., a program) including commands stored in machine (e.g., computer)-readable storage media. A machine is a device that can call a stored command from storage media and operate according to the called command and may include an electronic device (e.g., a server) according to disclosed embodiments. A command may include code generated or executed by an interpreter. Machine-readable storage media may be provided in the form of non-transitory storage media. Here, “non-transitory” merely means that storage media do not include a signal and are tangible and is not used to distinguish semi-permanent storage of data in storage media from temporary storage of data in storage media.

According to an embodiment, methods according to various embodiments disclosed in this specification may be provided by being included in computer program products. Computer program products can be transacted between a seller and a purchaser. Computer program products can be distributed online in the form of machine-readable storage media (e.g., a compact disc read only memory (CD-ROM)) or through application stores (e.g., Play Store™). In the case of online distribution, at least some computer program products may be at least temporarily stored in storage media such as memories of servers of manufacturers, servers of application stores, or intermediary servers, or temporarily generated.

Each component (e.g., a module or a program) according to various embodiments may be composed of a single or a plurality of entities, and some of the aforementioned corresponding sub-components may be omitted or other sub-components may be additionally included in various embodiments. Alternatively or additionally, some components (e.g., modules or programs) may be integrated into a single entity and execute functions thereof before being integrated in the same or similar manner. Operations performed by modules, programs or other components according to various embodiments may be executed sequentially, in parallel, repeatedly or heuristically, at least some operations may be executed in a different order or omitted, or other operations may be added.

Furthermore, although an article or a product is designated as a transaction object in the present specification, transaction objects are not necessarily limited to products and may be all works that can be generated by human creation. Here, works may include, for example, digital music sources, novels, poems, papers, lectures, scenarios, plays, dancing, painting, calligraphy, design, sculpture, crafts, architecture, pictures, figures, computer programs, etc.

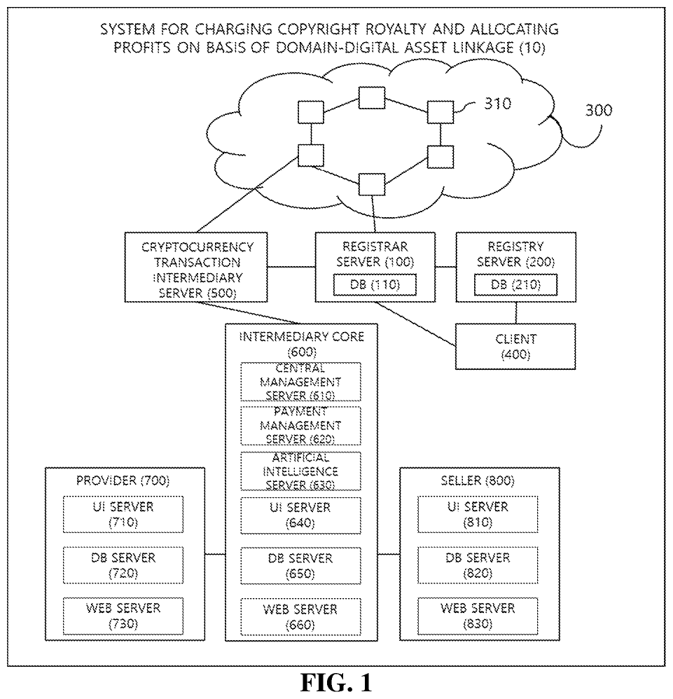

FIG. 1 is a block diagram illustrating a method and system for charging copyright royalty and allocating profits on the basis of domain-digital asset linkage according to an embodiment of the present disclosure. Hereinafter, a registrar server 100 and components connected thereto according to the present disclosure will be described with reference to FIG. 1. Parts which are not illustrated can be understood by the description. Further, representation of a network in FIG. 1 is an example and the range of the network is not limited to the range of the figure.

Referring to FIG. 1, the registrar server 100 according to the present disclosure may include or be connected to a database 110 in which domain entities or cryptocurrency transaction information are stored.

In addition, the registrar server 100 may be connected to a registry server 200, a network 300 having node servers 310 and a blockchain structure in which transaction records of digital coins are encrypted, a client 400 of a domain owner or a prospective owner, and/or a cryptocurrency transaction intermediary server 500. Here, the registrar server 100 may further include the DB 110 and the registry server 200 may also include a separate DB 210.

In the present disclosure, “blockchain” may mean a distributed computing storage method in which storage target data is stored in a distributed data storage environment as partial data in units of ‘block’ in the form of chains generated on the basis of peer to peer (P2P).

In the present disclosure, “node” may mean a constituent server of a network of a blockchain structure in which partial data in units of block or all storage target data chains are stored.

In the present disclosure, “cryptocurrency” may mean digital currency of which issuance and transaction records are distributed and stored in a network of a blockchain structure.

Cryptocurrency connected through a network of a blockchain structure according to the present disclosure may be blockchain based cryptocurrency in a form capable of implementing embodiments of the present disclosure or cryptocurrency modified to a form capable of implementing embodiments of the present disclosure from a conventional blockchain platform.

Digital coins according to the present disclosure may include copyright coins and the copyright coins may be issued on the basis of a copyright.

In an embodiment, the system 10 for charging copyright royalty and allocating profits on the basis of domain-digital asset linkage may include an intermediary core 600, a provider 700, and a seller 800 in order to perform charging for copyright royalty and allocation of profits on the basis of copyright coin issuance information. Here, the provider 700 and the seller 800 include a plurality of providers and a plurality of sellers, and the provider 700 may be an original copyright holder who creates an original work. In addition, the provider 700 may include a plurality of copyright holders because a plurality of copyright holders (e.g., a composer, a lyricist, and a singer) may be related to a single work. For example, the provider 700 and the seller 800 can sign up for the system 10 for charging copyright royalty and allocating profits through a web page of the intermediary core, and the provider 700 can register a supply product (e.g., a work created by the provider) in the system 10 for charging copyright royalty and allocating profits. The seller 800 can browse, search, select, and sell registered supply products. Here, supply products may mean works and include, for example, digital music sources, novels, poems, papers, lectures, scenarios, plays, dancing, painting, calligraphy, design, sculpture, crafts, architecture, pictures, figures, computer programs, etc. A transaction can be made between the provider 700 and the seller 800 through the intermediary core 600. The intermediary core 600, the provider 700, and the seller 800 may be concepts classified based on subjects that operate a plurality of servers included in the system for charging copyright royalty and allocating profits, devices operating in the system 10 for charging copyright royalty and allocating profits are respective servers illustrated in FIG. 1, which will be described below.

In an embodiment, the provider 700 and the seller 800 may be subjects that run businesses all over the world. For example, business fields of the provider 700 and the seller 800 may be the whole world.

In an embodiment, a plurality of servers belonging to the intermediary core 600, the provider 700, and the seller 800 can communicate through a network. Here, the network may include a wireless network and a wired network. For example, the aforementioned network may be a short-range communication network (e.g., Bluetooth, WiFi Direct, or infrared data association (IrDA)) or a telecommunication network (e.g., a cellular network, the Internet, or a computer network (e.g., a LAN or a WAN)).

In an embodiment, the intermediary core 600 may include a central management server 610, a payment management server 620, an artificial intelligence server 630, a UI server 640, a database (DB) server 650, and a web server 660. The central management server 610, the payment management server 620, the artificial intelligence server 630, the UI server 640, the database (DB) server 650, and the web server 660 may be linked, and information acquired by each server may be updated in the DB server 650. For example, when the provider 700 registers supply products and the seller 800 selects some of the supply products as selling products, it can be considered that a primary contract between the provider 700 and the seller 800 has been made. Thereafter, if a purchaser purchases a selling product and then a part of a deposit of the seller 800 is delivered to the provider 700 as a settlement amount, it can be considered that a secondary contract has been made and thus entire transaction contract is completed. Here, as the settlement amount is delivered to the provider 700, the deposit is reduced by the delivered settlement amount.

For example, the central management server 610 may manage information on supply products received from a web server 730 of the provider 700 and information on selling products of the seller received from a web server 830 of the seller 800 and update the DB server 650. In addition, the central management server 610 may integrally update a plurality of pieces of information on supply products acquired from a plurality of providers 700 and a plurality of pieces of selling products acquired from a plurality of sellers 800 in the DB server 650, analyze the information, and process the information into information in a new format. For example, information in a new format may include a latest trend (e.g., latest popular songs) with respect to works of the provider 700, a latest trend of products to be sold by the seller 800.

In an embodiment, when a request for correction of information on supply products is received from the provider 700 or additional information on supply products (newly created works) is registered, the center management server 610 may update the corresponding information in the DB server 650 and notify the web server 830 of the seller 800 of information update.

For example, information on a supply product may include description of the supply product, inventory, a supply price, a consumer price, a shipping charge, a category, etc. For example, description of a supply product may include the name or company name of the provider 700, the country name and address of the provider 700, business information of the provider 700, transaction condition information about conditions of the supply product (e.g., information on right holders with respect to a work), supply product standards, design, etc.

For example, information on selling products may include the names of products selected from supply products by the seller 800, the number of supply products, the company name of the seller 800, the country name and address of the seller 800, business information of the seller 800, etc.

For example, the payment management server 620 may store and manage deposits of sellers, information on purchase products of purchasers, settlement amounts of providers, etc. In addition, the payment management server 620 may provide details of transaction of supply products to the cryptocurrency transaction intermediary server 500. Furthermore, the payment management server 620 may allocate a settlement amount of a provider to a copyright holder on the basis of copyright coin issuance information.

For example, information on purchase products may include the names of purchase products of purchasers, the number of purchase products, and settlement costs.

For example, the artificial intelligence server 630 may analyze a massive amount of big data stored as databases in the DB server 650 of the intermediary core 600, a DB server 720 of the provider 700, and a DB server 820 of the seller 800 and generate a web page suitable for the seller 800.

For example, the UI server 640 may generate and store menus, buttons, text, banners, etc. of screens constituting an intermediary core web page and provide them to the web server.

For example, the database (DB) server 650 may store supply product information, selling product information, purchase product information, and settlement amounts as a database.

For example, the web server 660 may provide the intermediary core web page to the provider 700 and the seller 800. Here, intermediary core web page may be a website accessible by the provider 700 and the seller 800 online. The web server 660 may provide a means by which the provider 700 can register supply product information through the intermediary core web page, display a list of supply products on the intermediary core web page, and provide, to the seller 800, a means by which a plurality of supply products included in supply product information can be searched and selected. In addition, the web server 660 may link selling product information corresponding to a supply produce selection result of the seller 800 to the web page of the seller 800. Further, the web server 660 may update supply product registration of the provider 700, selling product selection of the seller 800, purchase product selection of a purchaser, and the like in real time and link the web server 730 of the provider 700 to the web server 830 of the seller 800 in real time.

In an embodiment, the provider 700 may include a UI server 710, the DB server 720, and the web server 730. The UI server 710, the DB server 720, and the web server 730 may be linked to one another, and information acquired by each server may be updated in the DB server 720.

For example, the UI server 710 may generate and store menus, buttons, text, banners, etc. of screens constituting the web page of the provider 700 and provide them to the web server 730. For example, the provider 700 may be present around the world, and thus supply products of the provider 700 can include a language used in a corresponding country, a design specific to the country, and a UI.

For example, the DB server 720 may store supply product information, purchase product information, and settlement amounts as a database.

For example, the web server 730 may communicate with the web server of the intermediary core 600 and provide the web page of the provider 700. In addition, the web server 730 may provide languages suitable for providers 700 present around the world (e.g., languages of countries where the providers 700 run businesses), designs, UIs, and the like to the web server 660, the UI server 640, or the DB server 650 of the intermediary core 600.

In an embodiment, the seller 800 may include a UI server 810, the DB server 820, and the web server 830. The UI server 810, the DB server 820, and the web server 830 may be linked to one another, and information acquired by each server may be linked to the DB server 820.

For example, the UI server 810 may generate and store menus, buttons, text, banners, etc. of screens constituting the web page of the seller 800 and provide them to the web server 830.

For example, the DB server 820 may store supply product information, purchase product information, and a deposit as a database.

For example, the web server 830 may communicate with the web server 660 of the intermediary core 600 and provide the web page of the seller 800.

The system 10 for charging copyright royalty and allocating profits may be a Mall In Mall In Mall application server program (ASP) system. Here, the Mall In Mall In Mall ASP system may mean a system in which a plurality of purchasers cannot ascertain presence of the intermediary core 600 and recognize that a plurality of web pages of a plurality of different sellers 800 are present although all web pages of the plurality of sellers 800 provided through the intermediary core 600 provide supply products through the same intermediary servers corresponding to the intermediary core 600. That is, a system in which purchasers can recognize sellers 800 as uninvolved independent sellers 800 although web pages of the sellers 800 use the same intermediary servers may be called a Mall In Mall In Mall ASP system.

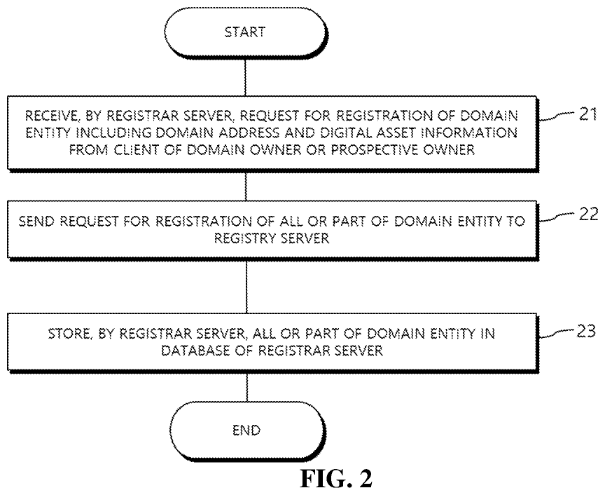

FIG. 2 is a flowchart for describing a method for charging copyright royalty and allocating profits on the basis of domain-digital asset linkage according to an embodiment of the present disclosure. Hereinafter, an embodiment of the method for charging copyright royalty and allocating profits of the present disclosure will be described with reference to FIG. 2.

Referring to FIG. 2, in the method for charging copyright royalty and allocating profits on the basis of domain-digital asset linkage according to an embodiment of the present disclosure, the registrar server 100 may receive, from the client 400 of a domain owner or a prospective owner, a request for registration of a domain entity including a domain address or digital asset information in operation 21.

In an embodiment, in the method for charging copyright royalty and allocating profits on the basis of domain-digital asset linkage, the registrar server 100 may send, to a registry, a request for registration of all or part of the domain entity in operation 22.

In an embodiment, the domain entity may include the domain address or the digital asset information or both the domain address and the digital asset information.

In an embodiment, the domain entity may include domain name system (DNS) information and can include, for example, a domain name, a name server name, and a name server Internet protocol (IP) number.

In an embodiment, registration of the domain entity may be new registration of the corresponding domain address or update of information related to the corresponding domain address.

In an embodiment, the digital asset information may be retention information on cryptocurrency in which a transaction record of digital coins is encrypted and connected to a network having node servers and a blockchain structure.

In the present disclosure, “digital coins” may mean digital assets that can be transacted on a network of a blockchain structure.

In an embodiment, digital coins may include copyright coins issued on the basis of copyrights. Copyright coins may include stand-alone copyright coins issued on the basis of an individual work and fund type copyright coins issued on the basis of a plurality of works. For example, stand-alone copyright coins may be copyright coins for one digital music source and fund type copyright coins may be copyright coins for a plurality of digital music sources.

In an embodiment, in the method for charging copyright royalty and allocating profits on the basis of domain-digital asset linkage, the registrar server 100 may store all or part of the domain entity in the database 110 of the registrar server 100 in operation 23. The retention information on cryptocurrency may be an address value of a cryptocurrency wallet. The address value may be finally stored in the database 210 of the registry server 200 or the database 110 of the registrar server 100 such that information such as the balance of the cryptocurrency wallet can be browsed by accessing a blockchain system.

In an embodiment, the retention information on cryptocurrency may include an asset ID of the cryptocurrency wallet or a private key value authorized for deposit and withdrawal. The asset ID is a value used to identify digital coins on a blockchain network, and a private key may be an authentication value used to deposit or withdraw digital coins of the cryptocurrency wallet on the blockchain network. The asset ID or the private key are finally stored in the database 210 of the registry server 200 or the database 110 of the registrar server 100 such that information such as the balance of the cryptocurrency wallet can be browsed by accessing the blockchain system and a corresponding cost can be paid using digital coins in time for update of domain owner information.

The retention information on cryptocurrency may include an application programming interface (API) key value authorized for deposit and withdrawal with respect to the cryptocurrency wallet. The asset ID is a value used to identify digital coins on the blockchain network, and an API key may be an authentication value used to call a function of depositing or withdrawing digital coins of the cryptocurrency wallet on the blockchain network. The API key is finally stored in the database 210 of the registry server 200 or the database 110 of the registrar server 100 such that information such as the balance of the cryptocurrency wallet can be browsed by accessing the blockchain system and a corresponding cost can be paid using digital coins in time for update of domain owner information.

In an embodiment, the retention information on cryptocurrency may include a private key value or an API key value for which authority for withdrawal from the cryptocurrency wallet is restricted. The asset ID or the API key for which authority for withdrawal is restricted can allow digital assets possessed by a domain owner to be officially announced, and thus the digital assets of the domain owner can function as a capital of a corporation.

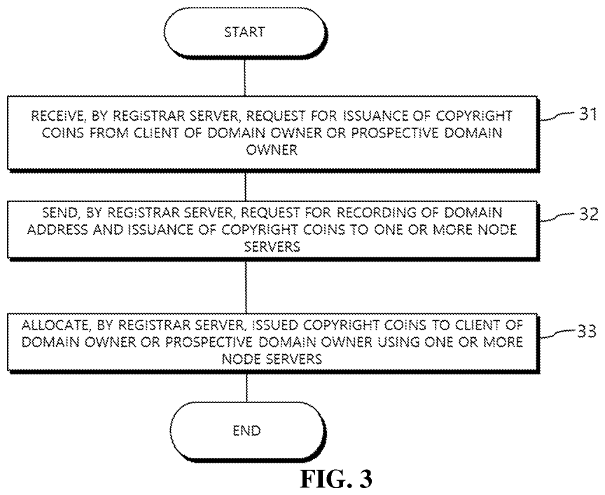

FIG. 3 is a flowchart for describing a method for issuing copyright coins according to an embodiment of the present disclosure. FIG. 3 illustrates a case in which a request for issuance of copyright coins is directly received from a copyright holder. Otherwise, information about copyright coins that have already been issued by a copyright holder may be registered in the registrar server 100.

Referring to FIG. 3, in the method for charging copyright royalty and allocating profits on the basis of domain-digital asset linkage according to an embodiment of the present disclosure, the registrar server 100 may receive a request for issuance of copyright coins from the client 400 of a domain owner or a prospective domain owner in operation 31. Here, the domain owner may be a copyright holder who owns his/her domain and the prospective domain owner may be a copyright holder who does not own a domain yet. For example, in the case of a copyright holder who does not own a domain, the registrar server 100 may generate a domain and provide the domain to the copyright holder, and register the generated domain.

In an embodiment, in the method for charging copyright royalty and allocating profits on the basis of domain-digital asset linkage, the registrar server 100 may send, to one or more node servers, a request for recording of a domain address and issuance of copyright coins in operation 32. Here, the domain address may correspond to a domain already possessed by the copyright holder or a domain directly generated by the registrar server 100 and provided to the copyright holder. Here, the copyright coins may include stand-alone copyright coins (e.g., one digital music source) and fund type copyright coins (e.g., a plurality of digital music sources), as described above.

In an embodiment, in the method for charging copyright royalty and allocating profits on the basis of domain-digital asset linkage, the registrar server 100 may allocate the issued copyright coins to the client 400 of the domain owner or the prospective domain owner using one or more of the node servers in operation 33. That is, when a copyright holder corresponding to a domain owner or a prospective domain owner requests issuance of copyright coins corresponding to 30% of the share of his/her copyright, copyright coins corresponding to the share can be issued and allocated to the copyright holder. Furthermore, the copyright holder may allocate copyright coins to a plurality of investors in proportion to amounts invested through the registrar server 100

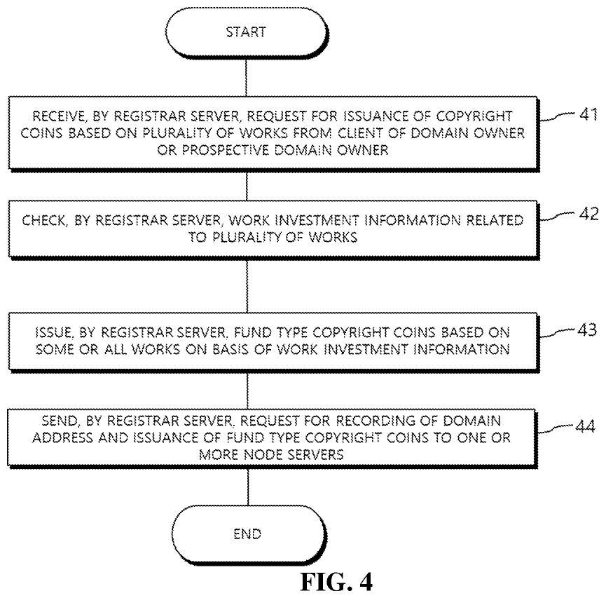

FIG. 4 is a flowchart for describing a method for issuing fund type copyright coins according to an embodiment of the present disclosure.

Referring to FIG. 4, in the method for charging copyright royalty and allocating profits on the basis of domain-digital asset linkage according to an embodiment of the present disclosure, the registrar server 100 may receive, from a client of a domain owner or a prospective domain owner, a request for issuance of copyright coins based on a plurality of works in operation 41. The copyright coins based on the plurality of works may be fund type copyright coins.

Specifically, fund type copyright coins will be described using a digital music source among works. Profits generated from a digital music source are divided into specific shares, and investors can estimate profits and progress investment in consideration of prospective for future profits. Here, each investor can buy individual copyright coins for a corresponding digital music source. However, copyright coins may be configured to be similar to a fund sold in a bank. For example, funds sold in a bank can be invested in 20 high ranking stock items listed on NASDAQ as one bundle investment instead of being invested in only one stock listed on NASDAQ. That is, in order to distribute risk of an investor, future directions of 20 high ranking items are predicted and funds are invested as a single function in all the 20 high ranking items instead of being invested in one stock. Likewise, in the case of investment in digital music sources or works, it is possible to invest, for example, in all digital music sources of Kim Gwang-Suk or in fund type copyright coins for a bundle of most popular digital music sources having similar backgrounds of the times, such as music sources of Kim Gwang-Suk, Zoo, Song Seeker, and the like, instead of investing in only one music source. In this case, since a copyright coin is the sum of sub-copyright coins, it is possible to invest in a sub-copyright coin instead of a copyright coin or invest in a fund type copyright coin corresponding to the sum of sub-copyright coins.

In an embodiment, in the method for charging copyright royalty and allocating profits on the basis of domain-digital asset linkage, the registrar server 100 may check work investment information related to the plurality of works in operation 42. The work investment information may include current values of the works, investment trend of business related to the works, investment preference of investors, investment plans, etc.

In an embodiment, in the method for charging copyright royalty and allocating profits on the basis of domain-digital asset linkage, the registrar server 100 may issue fund type copyright coins based on some or all of the plurality of works on the basis of the work investment information in operation 43. For example, fund type copyright coins including individual copyright coins for 20 latest popular ballads can be issued.

In an embodiment, in the method for charging copyright royalty and allocating profits on the basis of domain-digital asset linkage, the registrar server 100 may send, to one or more node servers, a request for recording of a domain address and issuance of fund type copyright coins in operation 44. Accordingly, it is possible to browse information about the fund type copyright coins issued through the domain and perform transaction using the fund type copyright coins.

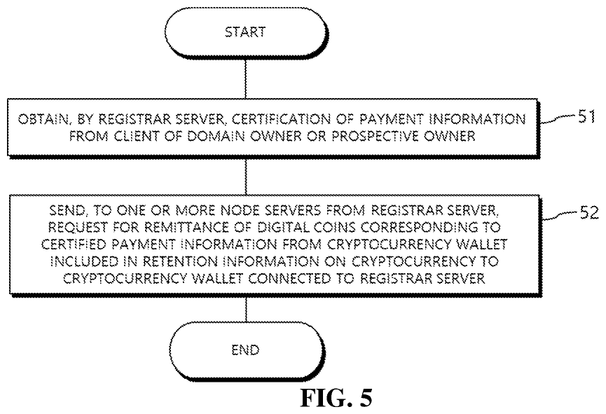

FIG. 5 is a flowchart for describing the method for charging copyright royalty and allocating profits on the basis of domain-digital asset linkage according to an embodiment of the present disclosure.

Referring to FIG. 5, in the method for charging copyright royalty and allocating profits on the basis of domain-digital asset linkage according to an embodiment of the present disclosure, the registrar server 100 may obtain certification of payment information from the client 400 of the domain owner or prospective owner in operation 51.

In an embodiment, in the method for charging copyright royalty and allocating profits on the basis of domain-digital asset linkage, the registrar server 100 may send, to one or more node servers, a request for remittance of an amount of digital coins corresponding to the certified payment information from the cryptocurrency wallet included in the retention information on cryptocurrency to a cryptocurrency wallet connected to the registrar server in operation 52. By performing these operations, it is possible to perform payment for a subject such as the registrar using digital assets of a corresponding domain without an additional payment information confirmation procedure.

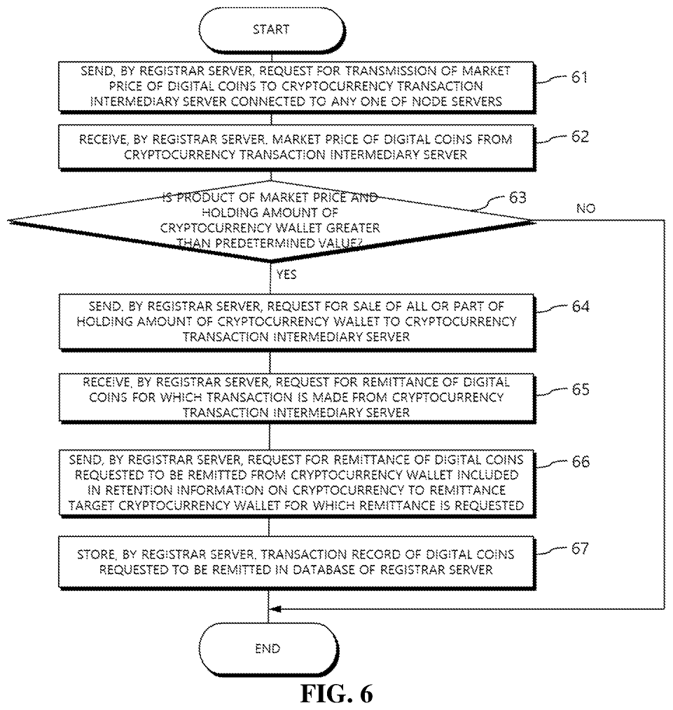

FIG. 6 is a flowchart for describing the method for charging copyright royalty and allocating profits on the basis of domain-digital asset linkage according to an embodiment of the present disclosure.

Referring to FIG. 6, in the method for charging copyright royalty and allocating profits on the basis of domain-digital asset linkage according to an embodiment of the present disclosure, the registrar server 100 may send a request for transmission of a market price value of digital coins to the cryptocurrency transaction intermediary server 500 connected to any one of node servers in operation 61.

In an embodiment, in the method for charging copyright royalty and allocating profits on the basis of domain-digital asset linkage, the registrar server 100 may receive the market price value of the digital coins from the cryptocurrency transaction intermediary server 500 in operation 62.

In an embodiment, in the method for charging copyright royalty and allocating profits on the basis of domain-digital asset linkage, the registrar server 100 may check whether a product of the market price value and the holding amount of the cryptocurrency wallet is greater than a predetermined value in operation 63.

In an embodiment, in the method for charging copyright royalty and allocating profits on the basis of domain-digital asset linkage, the registrar server 100 may send, to the cryptocurrency transaction intermediary server 500, a request for sale of all or part of the holding amount of the cryptocurrency wallet in operation 64.

In an embodiment, in the method for charging copyright royalty and allocating profits on the basis of domain-digital asset linkage, the registrar server 100 may receive, from the cryptocurrency transaction intermediary server 500, a request for remittance of digital coins for which transaction is made in operation 65.

In an embodiment, in the method for charging copyright royalty and allocating profits on the basis of domain-digital asset linkage, the registrar server 100 may send, to any one of the node servers, a request for remittance of an amount of digital coins requested to be remitted from the cryptocurrency wallet included in the retention information on cryptocurrency to a remittance target cryptocurrency wallet for which remittance is requested in operation 66.

In an embodiment, in the method for charging copyright royalty and allocating profits on the basis of domain-digital asset linkage, the registrar server 100 may store the transaction record of the digital coins requested to be remitted in the database of the registrar server 100 in operation 67.

For example, if digital assets deposited in the corresponding domain exceed a predetermined amount, coins can be listed on a cryptocurrency exchange through the operations of FIG. 6. Furthermore, if the digital assets deposited in the corresponding domain exceed a predetermined amount, it is possible to request coin listing on the cryptocurrency exchange and perform transaction of listed coins through the operations.

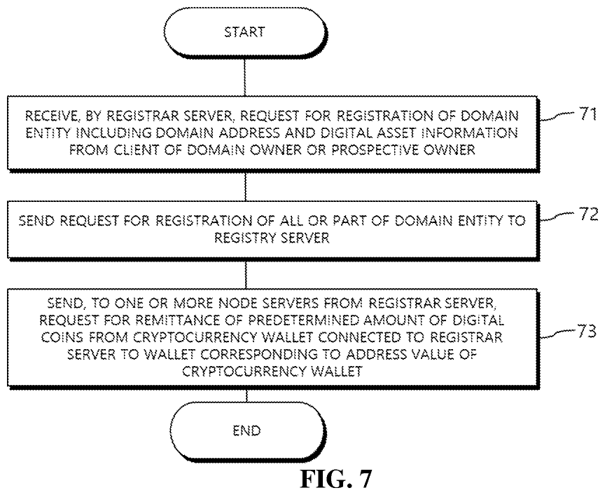

FIG. 7 is a flowchart for describing the method for charging copyright royalty and allocating profits on the basis of domain-digital asset linkage according to an embodiment of the present disclosure.

Referring to FIG. 7, in the method for charging copyright royalty and allocating profits on the basis of domain-digital asset linkage according to an embodiment of the present disclosure, the registrar server 100 may receive, from the client 400 of a domain owner or a prospective owner, a request for registration of a domain entity including a domain address and digital asset information in operation 71.

In an embodiment, in the method for charging copyright royalty and allocating profits on the basis of domain-digital asset linkage, the registrar server 100 may send, to the registry server 200, a request for registration of all or part of the domain entity in operation 72.

In an embodiment, in the method for charging copyright royalty and allocating profits on the basis of domain-digital asset linkage, the registrar server 100 may send, to one or more node servers, a request for remittance of a predetermined amount of digital coins from the cryptocurrency wallet connected to the registrar server to a wallet corresponding to an address value of the cryptocurrency wallet in operation 73. It is possible to execute payment using digital assets of the corresponding domain without performing an additional payment information checking procedure for a subject such as the registrar through the aforementioned operations.

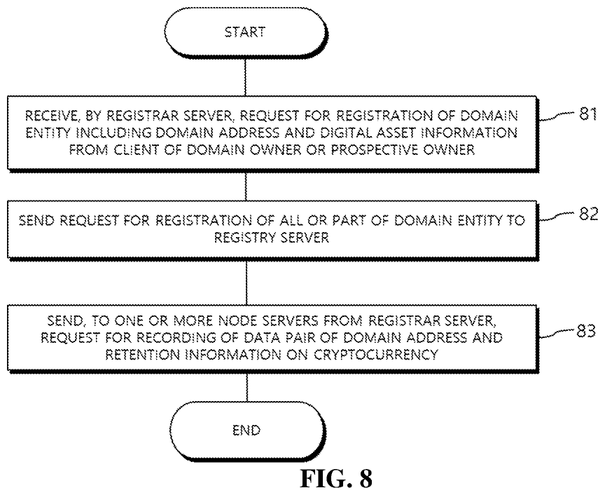

FIG. 8 is a flowchart for describing the method for charging copyright royalty and allocating profits on the basis of domain-digital asset linkage according to an embodiment of the present disclosure.

Referring to FIG. 8, in the method for charging copyright royalty and allocating profits on the basis of domain-digital asset linkage according to an embodiment of the present disclosure, the registrar server 100 may receive, from the client 400 of a domain owner or a prospective owner, a request for registration of a domain entity including a domain address and digital asset information in operation 81.

In an embodiment, in the method for charging copyright royalty and allocating profits on the basis of domain-digital asset linkage, the registrar server 100 may send, to the registry server 200, a request for registration of all or part of the domain entity in operation 82.

In an embodiment, in the method for charging copyright royalty and allocating profits on the basis of domain-digital asset linkage, the registrar server 100 may send, to one or more node servers, a request for recording of a data pair of the domain address and the retention information on cryptocurrency in operation 83. The data pair may be stored in such a manner that a correlation between the domain and digital coins are distributed in the blockchain, and specifically, may be recorded in attachment of digital coin transaction records.

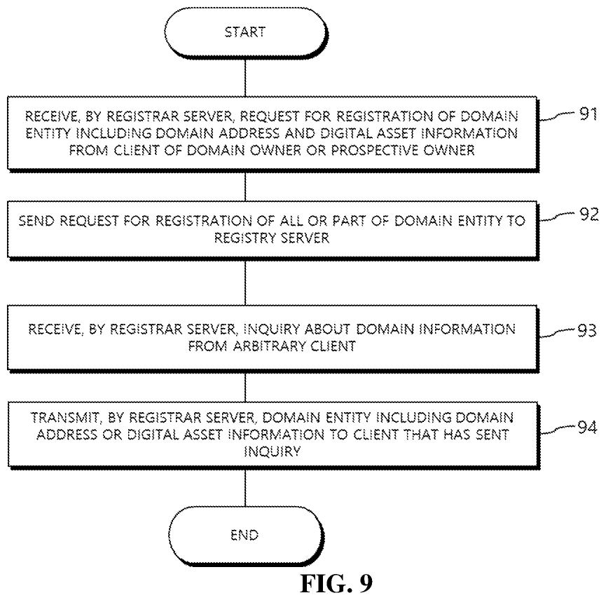

FIG. 9 is a flowchart for describing the method for charging copyright royalty and allocating profits on the basis of domain-digital asset linkage according to an embodiment of the present disclosure.

Referring to FIG. 9, in the method for charging copyright royalty and allocating profits on the basis of domain-digital asset linkage according to an embodiment of the present disclosure, the registrar server 100 may receive, from a client of a domain owner or a prospective owner, a request for registration of a domain entity including a domain address and digital asset information in operation 91.

In an embodiment, in the method for charging copyright royalty and allocating profits on the basis of domain-digital asset linkage, the registrar server 100 may send, to the registry server 200, a request for registration of all or part of the domain entity in operation 92.

In an embodiment, in the method for charging copyright royalty and allocating profits on the basis of domain-digital asset linkage, the registrar server 100 may receive an inquiry about domain information from an arbitrary client in operation 93.

In an embodiment, in the method for charging copyright royalty and allocating profits on the basis of domain-digital asset linkage, the registrar server 100 may transmit the domain entity including the domain address or the digital asset information to the client that has sent the inquiry about the domain information in operation 94. It is possible to issue digital coins (e.g., copyright coins) in addition to registration of the corresponding domain name and allocate the digital coins issued in the corresponding domain name to a digital coin holder through the aforementioned operations. Further, it is possible to officially announce information on digital assets deposited in the corresponding domain, specifically, a domain name of a digital token issuance subject, an asset ID, a cryptocurrency wallet address, and a holding amount of digital tokens of a domain owner, receive a domain entity inquired about by the client 400 and display the domain entity through the aforementioned operations. The retention information on cryptocurrency may be retention information on at least one type of cryptocurrency. Further, retention information on a digital token may be retention information on at least one type of digital token.

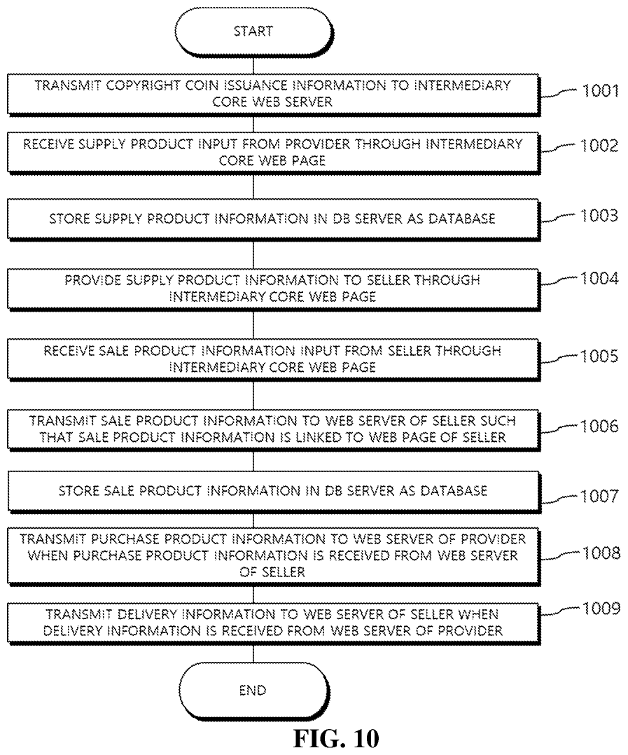

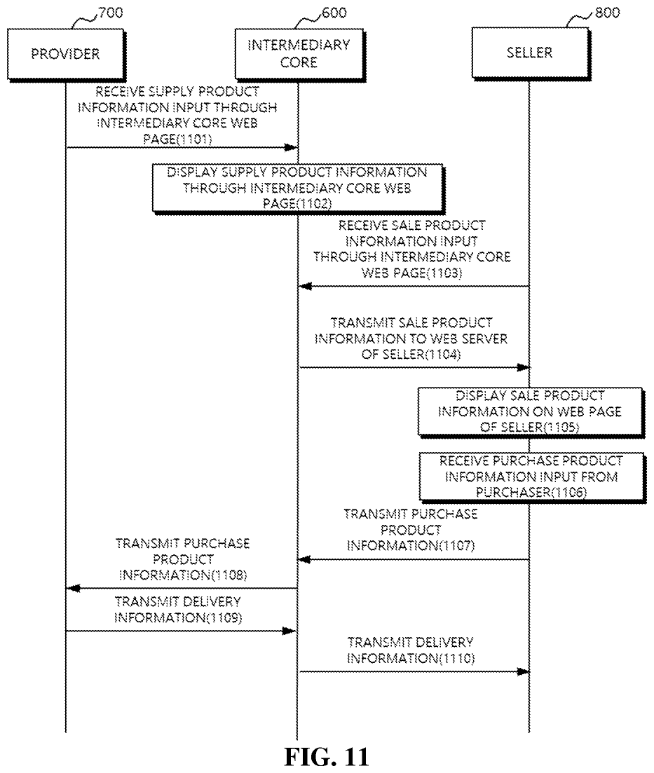

FIG. 10 is a flowchart for describing the method for charging copyright royalty and allocating profits on the basis of domain-digital asset linkage according to an embodiment of the present disclosure. FIG. 11 is a flowchart for describing a method for charging copyright royalty and allocating profits among an intermediary core, a provider, and a seller according to an embodiment of the present disclosure.

Referring to FIG. 10, in an embodiment, in the method for charging copyright royalty and allocating profits on the basis of domain-digital asset linkage, the registrar server 100 may transmit copyright coin issuance information to the intermediary core web server 660 in operation 1001. For example, the copyright coin issuance information may include information such as a work related to copyright coins, and a copyright coin owner.

In an embodiment, in the method for charging copyright royalty and allocating profits on the basis of domain-digital asset linkage, supply product information input may be received from the provider 700 through the intermediary core web page in operation 1002. For example, the web server 660 of the intermediary core 600 may receive the supply product information through the intermediary core web page, store the supply product information, and transmit the supply product information to the DB server 650 (operation 1101 of FIG. 11).

As described above, the supply product information may include supply product description, inventory, a delivery fee, a category, etc. For example, the supply product description may include the name or company name of the provider 700, the country name and address of the provider 700, business information of the provider 700, transaction condition information about conditions (e.g., a new product, used, or leased) of supply products, supply product size, design, etc.

In an embodiment, the system 10 for intermediating an electronic commerce may store the supply product information as a database in the DB server 650 in operation 1003. For example, the DB server 650 of the intermediary core 600 may store the supply product information received from the web server 660 as a database.

In an embodiment, the system 10 for intermediating an electronic commerce may provide the supply product information to the seller 800 through the intermediary core web page in operation 1004. For example, the web server 660 may display the supply product information in the form of a list such that the seller 800 can select a supply product (operation 1102 of FIG. 11).

In an embodiment, the system 10 for intermediating an electronic commerce may receive sale product information input from the seller 800 through the intermediary core web page in operation 1005. For example, the web server 660 may receive input of the seller 800 that selects at least one from the supply product information list through the intermediary core web page (operation 1103 of FIG. 11). Further, the web server 660 may transmit sale product information to the DB server 650.

As described above, for example, the sale product information may include the name of a product selected by the seller 800 from supply products, the number of supply products, the name of the seller 800, the country name and address of the seller 800, business information of the seller 800, etc.

In an embodiment, the system 10 for intermediating an electronic commerce may transmit the sale product information to the web server 830 of the seller 800 such that the sale product information is linked to the web page of the seller 800 in operation 1006. For example, the web server 660 of the intermediary core 600 may transmit related data to the web server 830 of the seller 800 such that the sale product information is displayed on the web page of the seller 800 (operation 1104 of FIG. 11). Accordingly, the web server 830 of the seller 800 can display the sale product information through the web page of the seller 800 (1105 of FIG. 11).

According to an embodiment of the present disclosure, the web server 660 of the intermediary core 600 and the web server 830 of the seller 800 may be synchronized with each other and share the sale product information in real time.

In an embodiment, the system 10 for intermediating an electronic commerce may store the sale product information as a database in the DB server 650 in operation 1007. For example, the DB server 650 of the intermediary core 600 may store the sale product information received from the web server 660 as a database.

In an embodiment, the system 10 for intermediating an electronic commerce may transmit purchase product information to the web server 730 of the provider 700 when the purchase product information is received from the web server 830 of the seller 800 in operation 1008. For example, the web server 830 of the seller 800 may receive input of purchase product information from a purchaser and transmit the purchase product information to the web server 660 of the intermediary core 600 (operations 1106 and 1107 of FIG. 11). The web server 660 of the intermediary core 600 may transmit the purchase product information to the web server 730 of the provider 700 and the DB server 650 of the intermediary core 600 (operation 1108 of FIG. 11). The DB server 650 of the intermediary core 600 may store the purchase product information as a database.

For example, the purchase product information may include the name of a product purchased by the purchaser, the number of purchased products, and a settlement cost.

In an embodiment, the system 10 for charging copyright royalty and allocating profits may check a settlement price in the purchase product information of the purchaser through the payment management server 620, deduct an amount corresponding to the settlement price from a deposit, and determine the deducted amount as a settlement amount.

In an embodiment, the system 10 for intermediating an electronic commerce may transmit delivery information to the web server 830 of the seller 800 when the delivery information is received from the web server 730 of the provider 700 in operation 1009. For example, the web server 660 of the intermediary core 600 may transmit the delivery information to the web server 830 of the seller 800 when the delivery information is received from the provider 700 (operations 1109 and 1110 of FIG. 11).

For example, the delivery information may include a purchase product delivery state such as a delivery destination of the purchased produce, whether delivery is completed, a delivery completion time, and a delivery accident.

In an embodiment, the system 10 for charging copyright royalty and allocating profits may transmit the determined settlement amount (deducted amount) to the provider when purchase confirmation information is received. For example, the payment management server 620 may transmit the settlement amount to the web server 730 or the DB server 720 of the provider 700 when the purchase confirmation information is received through the web server 830 of the seller 800. For example, the purchase confirmation information may include details of acknowledgement of reception of the product sent from the purchaser through the web page of the seller 800 after reception of the product.

Meanwhile, the system 10 for charging copyright royalty and allocating profits may allocate the determined settlement amount (deducted amount) to corresponding right holders on the basis of the copyright coin issuance information, for example. For example, when the sold product relates to copyright coins, the settlement amount can be allocated to right holders that possess the corresponding copyright coins. Here, the right holders may be an original copyright holder and investors.

Meanwhile, according to an embodiment of the present disclosure, the central management server 610 of the intermediary core 600 may perform the above-described operations 1001 to 1009 and transmit commands of the operations and a result of each command. That is, the central management server 610 can manage the overall system 10 for charging copyright royalty and allocating profits of the present disclosure.

For smooth understand of the present disclosure, operations of the present disclosure based on a deposit, a settlement cost, and a settlement amount will be described in detail below.

In an embodiment, the system 10 for charging copyright royalty and allocating profits may receive a deposit (e.g., 60 million won) from the seller 800, provide a price of a supply product (e.g., 70,000 won) of the provider 700 to the seller 800, receive a purchase input (e.g., a purchase price of 100,000 won) from a purchaser through the web page of the seller 800, deduct the price of the supply product or service from the deposit and check the current amount of the deposit (e.g., 60 million won-70,000 won), determine the price of the supply product or service as a settlement amount (e.g., 70,000 won), request delivery from the provider 700, and deliver the settlement amount to the provider 700 when acknowledgement information representing that the provider 700 has sent the supply product or has provided the service is received from the purchaser. Here, the deposit is reduced by the settlement amount (to 9,930,000 won) as the settlement amount is delivered to the provider 700. The aforementioned operations may be performed by the central management server 610, the payment management server, or the web server 660 of the intermediary core 600.

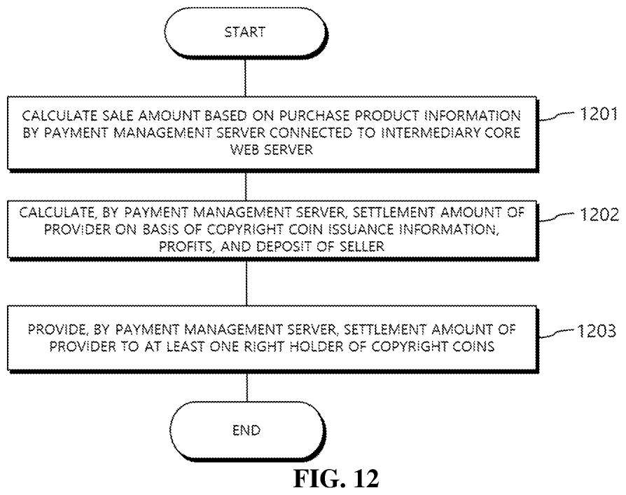

FIG. 12 is a flowchart for describing a method for calculating a payment of a provider according to an embodiment of the present disclosure.

Referring to FIG. 12, in the system 10 for charging copyright royalty and allocating profits according to an embodiment of the present disclosure, the payment management server 620 connected to the intermediary core web server may calculate a sale amount on the basis of purchase product information in operation 1201.

In the system 10 for charging copyright royalty and allocating profits according to an embodiment of the present disclosure, the payment management server 620 may calculate a settlement amount of a provider on the basis of copyright coin issuance information, the sale amount, and a deposit of a seller in operation 1202.

In the system 10 for charging copyright royalty and allocating profits according to an embodiment of the present disclosure, the payment management server 620 may provide the settlement amount of the provider to at least one right holder of copyright coins in operation 1203. Profits according to distribution of a work can be allocated to right holders of copyright coins through the aforementioned operations, and safe transaction can be achieved because such profit allocation is recorded through a blockchain network.

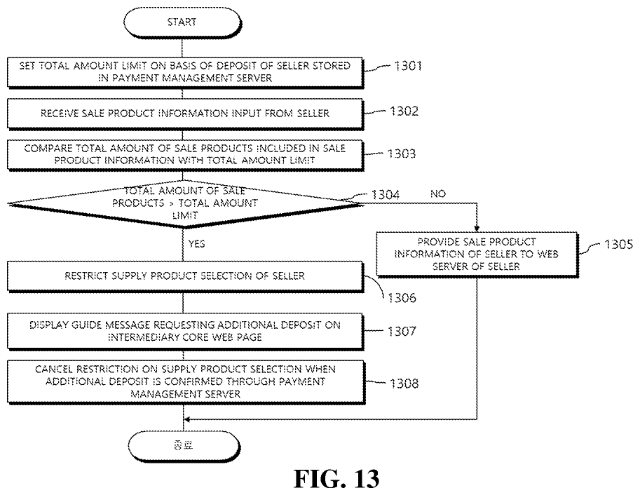

FIG. 13 is a flowchart for describing a purchase limit of a seller according to a deposit of the seller and a total amount limit according to an embodiment of the present disclosure.

Referring to FIG. 13, the system 10 for charging copyright royalty and allocating profits according to an embodiment of the present disclosure may set a total amount limit on the basis of the deposit of the seller 800 stored in the payment management server 620 in operation 1301. For example, the payment management server 620 may set the total amount limit depending on the amount of the deposit when the deposit is received from the seller 800. For example, the total amount limit may be 0.8 times to twice the deposit.

In an embodiment, the system 10 for charging copyright royalty and allocating profits may receive input of sale product information from the seller 800 in operation 1302. For example, the web server 660 of the intermediary core 600 may receive input of sale product information from the seller 800 through the intermediary core web page and transmit the received sale product information to the payment management server 620.

In an embodiment, the system 10 for charging copyright royalty and allocating profits may compare a total amount of sale products included in the sale product information with the total amount limit in operation 1303. For example, the payment management server 620 may calculate the total amount of the sale products on the basis of the received sale product information and compare the total amount of the sale products with the preset total amount limit.

In an embodiment, the system 10 for charging copyright royalty and allocating profits may check whether the total amount of the sale products is greater than the total amount limit as a comparison result in operation 1304. This may be an operation for a safety device for stably paying a settlement amount to the provider 700 using the deposit of the seller 800.

In an embodiment, if the total amount of the sale products is less than the total amount limit, the system 10 for charging copyright royalty and allocating profits may proceed to operation 1305 and provide the sale product information of the seller 800 to the web server 830 of the seller 800.

In an embodiment, if the total amount of the sale products is greater than the total amount limit, the system 10 for charging copyright royalty and allocating profits may proceed to operation 1306 and restrict supply product selection of the seller 800. For example, the web server 660 of the intermediary core 600 may deactivate a selection menu such that the seller 800 can no more select supply products.

In an embodiment, the system 10 for charging copyright royalty and allocating profits may display a guide message requesting an additional deposit on the intermediary core web page in operation 1307. For example, the web server 660 of the intermediary core 600 may display the guide message on the intermediary core web page in the form of a pop-up window.

In an embodiment, the system 10 for charging copyright royalty and allocating profits may cancel restriction on supply product selection when the additional deposit is confirmed through the payment management server 620 in operation 1308. Accordingly, the seller 800 can reselect supply products.

Meanwhile, according to an embodiment of the present disclosure, when a total deposit increases to be higher than the previous total amount of the deposit as the seller 800 deposits the additional deposit, the payment management server 620 may reset a total amount limit on the basis of the increased total deposit.

Meanwhile, according to an embodiment of the present disclosure, the central management server 610 of the intermediary core 600 may perform the operations 1301 to 1308 and transmit commands of the operations and a result of each command. That is, the central management server 610 can manage the overall system 10 for charging copyright royalty and allocating profits of the present disclosure.

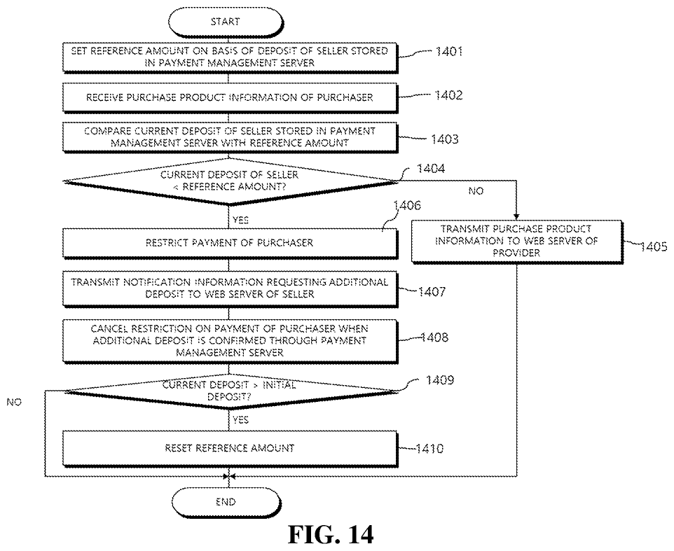

FIG. 14 is a flowchart for describing a payment limit of a purchaser according to a deposit of a seller and a reference amount according to an embodiment of the present disclosure.

Referring to FIG. 14, the system 10 for charging copyright royalty and allocating profits according to an embodiment of the present disclosure may set a reference amount on the basis of the deposit of the seller 800 stored in the payment management server 620 operation 1401. For example, the payment management server 620 may set the reference amount depending on an initial amount of deposit when the deposit is received from the seller 800. Here, the initial amount of deposit may be a total amount initially deposited by the seller 800 before the seller 800 purchases a supply product or service. For example, the reference amount may be set to a range of 1% to 20% of the total amount of the initial deposit. The range of 1% to 20% may be an example and the reference amount may be set within an appropriate range of the total amount of the deposit.

In an embodiment, the system 10 for charging copyright royalty and allocating profits may receive purchase product information of a purchaser in operation 1402. For example, the web server 660 of the intermediary core 600 may receive the purchase product information through the web server 830 of the seller 800.

In an embodiment, the system 10 for charging copyright royalty and allocating profits may compare a current deposit of the seller 800 stored in the payment management server 620 with the reference amount in operation 1403. Here, the current deposit may be equal to the initial deposit or an amount obtained by deducting a settlement amount from the initial deposit once or more, and the reference amount may be within a range of 1% to 20% of the initial deposit.

In an embodiment, the system 10 for charging copyright royalty and allocating profits may check whether the current deposit of the seller 800 is less than the reference amount in operation 1404. That is, when a settlement amount is deducted from the initial deposit and thus the deposit decreases to be lower than a predetermined mount, the settlement amount may not be paid to the provider 700. Accordingly, it is possible to induce stable transaction by setting a minimum reference amount and comparing a deposit therewith.

In an embodiment, if the deposit of the seller 800 is greater than the reference amount, the system 10 for charging copyright royalty and allocating profits may proceed to operation 1405 and transmit the purchase product information to the set server 730 of the provider 700.

In an embodiment, if the deposit of the seller 800 is less than the reference amount, the system 10 for charging copyright royalty and allocating profits may proceed to operation 1406 and restrict payment of the purchaser. For example, the payment management server 620 may transmit a command for restricting a payment function of the intermediary core web page to the web server 660 of the intermediary core 600, and the web server 660 of the intermediary core 600 may deactivate a payment menu of the web server 660.

In an embodiment, the system 10 for charging copyright royalty and allocating profits may transmit a notification message requesting an additional deposit to the web server 830 of the seller 800 in operation 1407. For example, the web server 660 of the intermediary core 600 may transmit the notification message to the web server of the seller 800 or a smartphone of the seller 800 such that the seller 800 can recognize a situation in which purchase of the purchaser is currently restricted.

In an embodiment, the system 10 for charging copyright royalty and allocating profits may cancel restriction on payment of the purchaser when the additional deposit is confirmed through the payment management server 620 in operation 1408. For example, the payment management server 620 may transmit a command for cancelling payment restriction to the web server 660, and the web server 660 may activate the deactivated payment menu.

In an embodiment, the system 10 for charging copyright royalty and allocating profits may check whether a current deposit to which the additional deposit has been added is greater than the initial deposit in operation 1409. For example, the payment management server 620 may check whether the amount of the current deposit exceeds the initial amount of deposit due to addition of the additional deposit.

In an embodiment, if the current deposit is less than the initial deposit, the system 10 for charging copyright royalty and allocating profits may end the corresponding procedure.

In an embodiment, if the current deposit is greater than the initial deposit, the system 10 for charging copyright royalty and allocating profits may proceed to operation 1410 and reset a reference amount. For example, the payment management server 620 may reset the reference amount to a range of 1% to 20% of the increased total amount of deposit. The range of 1% to 20% may be an example and the reference amount may be set within an appropriate range of the total amount of the deposit.

Meanwhile, according to an embodiment of the present disclosure, the central management server 610 of the intermediary core 600 may perform the above-described operations 1401 to 1407 and transmit commands of the operations and a result of each command. That is, the central management server 610 can manage the overall system 10 for charging copyright royalty and allocating profits of the present disclosure.

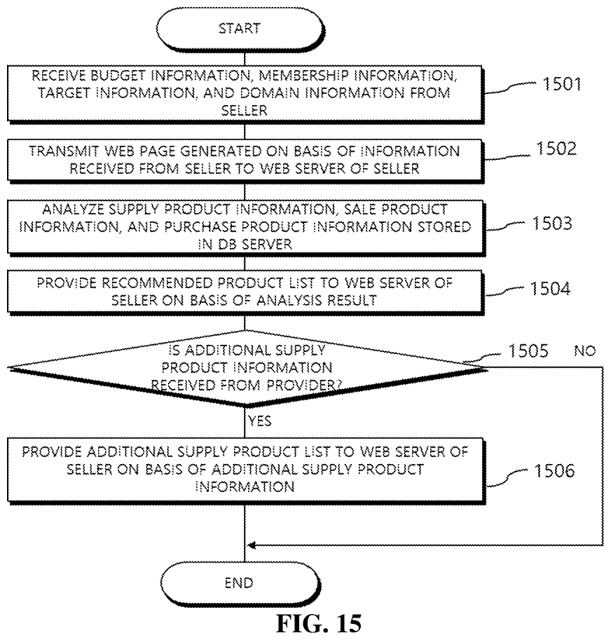

FIG. 15 is a flowchart for describing an operation of an artificial intelligence server in the method for charging copyright royalty and allocating profits according to an embodiment of the present disclosure.

Referring to FIG. 15, the system 10 for charging copyright royalty and allocating profits according to an embodiment of the present disclosure may receive budget information, membership information, target information, and domain information from the seller 800 operation 1501. For example, the web server 660 of the intermediary core 600 may receive the budget information, membership information, target information, and domain information from the web server 830 of the seller 800. Alternatively, the web server 660 of the intermediary core 600 may directly receive the budget information, membership information, target information, and domain information from the seller 800. Here, the budget information may include a total purchase payment of available sale products of the seller 800, that is, a deposit, the membership information may include the name, business license, and the like of the seller 800, the target information may include target products that the seller 800 intends to sell, a target class (e.g., women in their 20s), and the like, and the domain information may include a web page address of the seller 800. Furthermore, the web server 660 of the intermediary core 600 may transmit the budget information, membership information, target information, and domain information to the artificial intelligence server 630 and the DB server 650. The DB server 650 may store the budget information, membership information, target information, and domain information as a database.

The system 10 for charging copyright royalty and allocating profits according to an embodiment of the present disclosure may transmit a web page generated on the basis of the information received from the seller 800 to the web server of the seller 800 in operation 1502. For example, the artificial intelligence server 630 may integrally analyze the budget information, membership information, target information, and domain information stored as a database, generate a web page suitable for the seller 800, and provide the web page.

The system 10 for charging copyright royalty and allocating profits according to an embodiment of the present disclosure may analyze supply product information, sale product information, purchase product information stored in the DB server 650 in operation 1503. For example, the artificial intelligence server 630 may analyze the supply product information, sale product information, purchase product information stored as a database and determine recommended products having high recent purchase rates.

The system 10 for charging copyright royalty and allocating profits according to an embodiment of the present disclosure may provide a recommended product list to the web server of the seller 800 on the basis of an analysis result in operation 1504. For example, the artificial intelligence server 630 may transmit a list including recommended products acquired as an analysis result to the web server 830 of the seller 800.

The system 10 for charging copyright royalty and allocating profits according to an embodiment of the present disclosure may check whether additional supply product information from the provider 700 in operation 1505.

If additional supply product information is not received from the provider 700, the system 10 for charging copyright royalty and allocating profits may end the corresponding procedure.

On the other hand, if additional supply product information is received from the provider 700, the system 10 for charging copyright royalty and allocating profits according to an embodiment of the present disclosure may proceed to operation 1506 and provide a list of additional supply products and services to the web server 830 of the seller 800 on the basis of additional supply product and service information. For example, the artificial intelligence server 630 or the web server 660 of the intermediary core 600 may transmit the additional supply product list to the web server 830 of the seller 800.

Meanwhile, according an embodiment of the present invention, the order of the operations of the system 10 for charging copyright royalty and allocating profits, illustrated in FIG. 15, may be changed. For example, operations 1503 and 1504 may be performed after execution of operations 1505 and 1506. That is, the operations of the system 10 for charging copyright royalty and allocating profits may be performed in a sequence different from FIG. 15.

Meanwhile, according an embodiment of the present invention, the central management server 610 of the intermediary core 600 may perform the above-described operations 1501 to 1506 and transmit commands of the operations and a result of each command. That is, the central management server 610 can manage the overall system 10 for charging copyright royalty and allocating profits of the present disclosure.

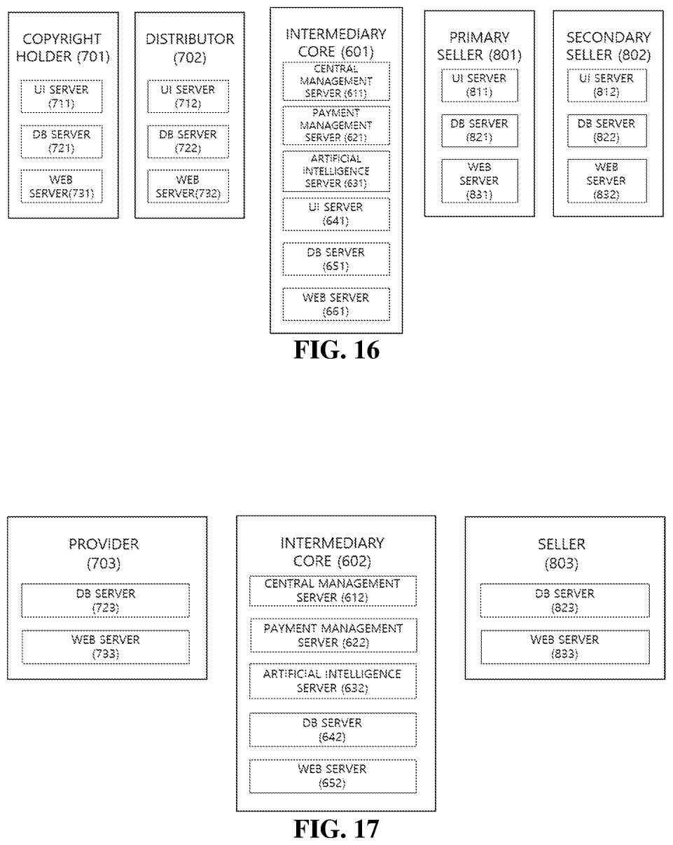

FIG. 16 is a block diagram illustrating a system for charging copyright royalty and allocating profits according to another embodiment of the present disclosure. Redundant description in FIG. 1 and FIG. 16 will be omitted in the following.

Referring to FIG. 16, an electronic commerce among a copyright holder 701, a distributor 702, a primary seller 801, a secondary seller 802, and a purchaser according to another embodiment of the present disclosure may be achieved through the system 10 for charging copyright royalty and allocating profits. For example, the copyright holder 701, the distributor 702, the primary seller 801, and the secondary seller 802 may sign up for the system for charging copyright royalty and allocating profits through an intermediate core web page, the copyright holder 701 and the distributor 702 may respectively register a supply product created thereby and a supply product distributed thereby in the system 10 for charging copyright royalty and allocating profits, and the primary seller 801 and the second seller 802 may browse, search, select, and sell registered supply products.

The system 10 for charging copyright royalty and allocating profits according to an embodiment of the present disclosure may include an intermediary core 601, the copyright holder 701, the distributor 702, the primary seller 801, and the secondary seller 802. The copyright holder 701, the distributor 702, the primary seller 801, and the secondary seller 802 may perform transaction through the intermediary core 601. The intermediary core 601, the copyright holder 701, the distributor 702, the primary seller 801, and the secondary seller 802 may be classified on the basis of subjects that operate a plurality of servers included in the system 10 for charging copyright royalty and allocating profits, and devices operating in the system 10 for charging copyright royalty and allocating profits of the present disclosure are servers illustrated in FIG. 16 which will be described below.

In an embodiment, each server of the intermediary core 601 is the same as that illustrated in FIG. 1 and thus description thereof is omitted. However, the central management server 611, the payment management server 621, the artificial intelligence server 631, the UI server 641, the DB server 651, and the web server 661 may additionally manage the distributor 702 and the secondary seller 802 unlike those illustrated in FIG. 1. Management methods are the same as those illustrated in FIG. 1.

For example, in an embodiment, the central management server 611 may update distributed product information in the DB server 651 in real time and notify the web server 831 of the primary seller 801 of the update when the distributor 702 registers the distributed product information.

For example, the payment management server 621 may store and manage a deposit of the primary seller 801, purchase product information of a purchaser, a settlement amount of the distributor 702, etc.

For example, the artificial intelligence server 631 may analyze a massive amount of big data stored as databases in a DB server 651 of the intermediary core 601, a DB server 721 of the copyright holder 701, a DB server 722 of the distributor 702, a DB server 821 of the primary seller 801, and a DB server 822 of the secondary seller 802 and generate a web page suitable for the primary seller 801 or the secondary seller 802.

For example, the DB server 651 may store supply product information, distributed product information, primary sale product information, secondary sale product information, purchase product information, and settlement amounts as a database.

For example, the web server 661 may provide the intermediary core web page to the copyright holder 701, the distributor 702, the primary seller 801, and the secondary seller 802.

In an embodiment, servers included in the copyright holder 701 and the distributor 702 may execute the same functions as those of the servers of the provider 801 in FIG. 1, and servers included in the primary seller 801 and the secondary seller 802 may execute the same functions as those of the servers of the seller 802 in FIG. 1.

In an embodiment, the copyright holder 701 may transmit/receive data to/from the distributor 702 without directly transmitting/receiving data to/from each server of the intermediary core 601, and the distributor 702 may transmit supply product information and distributed product information to each server of the intermediary core 601. Alternatively, the copyright holder 701 may directly transmit/receive data to/from each server of the intermediary core 601 without passing through the distributor 702.

In an embodiment, the secondary seller 802 may transmit/receive data to/from the primary seller 801 without directly transmitting/receiving data to/from each server of the intermediary core 601, and the primary seller 801 may transmit primary sale product information and secondary sale product information to each server of the intermediary core 601. Alternatively, the secondary seller 802 may directly transmit/receive data to/from each server of the intermediary core 601 without passing through the first seller 801.

FIG. 17 is a block diagram illustrating a system for charging copyright royalty and allocating profits according to another embodiment of the present disclosure. Redundant description in FIG. 1 and FIG. 17 will be omitted in the following.

Referring to FIG. 17, in the system 10 for charging copyright royalty and allocating profits according to another embodiment of the present disclosure, a UI server and a web server are integrated such that the web server can execute the function of the UI server. Operations and functions of other components are the same as those in FIG. 1 and thus description thereof is omitted.

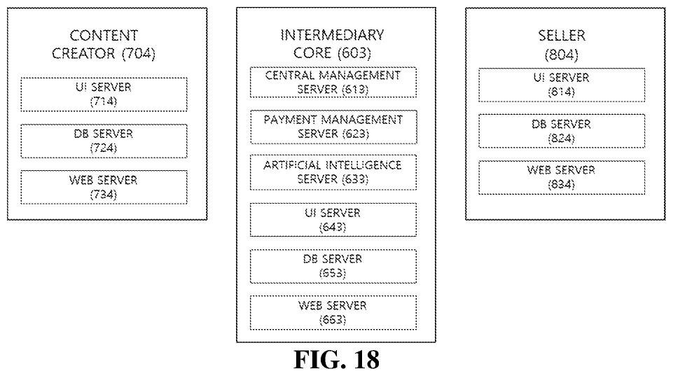

FIG. 18 is a block diagram illustrating a system for charging copyright royalty and allocating profits according to another embodiment of the present disclosure. Redundant description in FIG. 1 and FIG. 18 will be omitted in the following.

Referring to FIG. 18, an electronic commerce among a content creator 704, a seller 804, and a purchaser according to the present disclosure may be performed through the system 10 for charging copyright royalty and allocating profits. Here, the content creator 704 may be a person who generates and provides content, and content may include music, videos, images, text, etc. In an embodiment, the content creator 704 and the seller 804 may be subjects that run businesses all over the world. For example, business fields of the content creator 704 and the seller 804 may be the whole world.

The system 10 for charging copyright royalty and allocating profits illustrated in FIG. 18 may execute the same functions and operations as those of the system 10 for charging copyright royalty and allocating profits illustrated in FIG. 1 except that the content creator 704 instead of the provider generates content and provides the content to the seller 804 that supplies and sells content. Accordingly, detailed description of each server is omitted.

According to various embodiments of the present disclosure, a method for charging copyright royalty and allocating profits, by a registrar server, on the basis of domain-digital asset linkage, may include: receiving, by the registrar server, a request for registration of a domain entity including a domain address and digital asset information from a client of a domain owner or a prospective owner; and sending, by the registrar server, a request for registration of all or part of the domain entity to a registry server, wherein the digital asset information is retention information on cryptocurrency in which transaction records of digital coins are encrypted and connected to a network having node servers and a blockchain structure, and the digital coins include copyright coins issued on the basis of a copyright.

According to various embodiments, the copyright coins may include stand-alone copyright coins issued on the basis of an individual work and fund type copyright coins issued on the basis of a plurality of works.

According to various embodiments, the method for charging copyright royalty and allocating profits on the basis of domain-digital asset linkage may include: receiving, by the registrar server, a request for issuance of copyright coins from a client of a domain owner or a prospective domain owner; and sending, by the registrar server, a request for recording of the domain address and issuance of the copyright coins to one or more of the node servers.

According to various embodiments, the method for charging copyright royalty and allocating profits on the basis of domain-digital asset linkage may include allocating, by the registrar server, the issued copyright coins to the client of the domain owner or the prospective domain owner using the one or more of the node servers.

According to various embodiments, the method for charging copyright royalty and allocating profits on the basis of domain-digital asset linkage may include: receiving, by the registrar server, a request for issuance of copyright coins based on a plurality of works from a client of a domain owner or a prospective domain owner; checking, by the registrar server, work investment information related to the plurality of works; issuing, by the registrar server, fund type copyright coins based on some or all of the plurality of works on the basis of the work investment information; and sending, by the registrar server, a request for recording of the domain address and issuance of the fund type copyright coins to one or more of the node servers.

According to various embodiments, the method for charging copyright royalty and allocating profits on the basis of domain-digital asset linkage may include may further include storing, by the registrar server, all or part of the domain entity in a database of the registrar server.

According to various embodiments, the retention information on cryptocurrency may include an asset ID of a cryptocurrency wallet or a private key value authorized for deposit and withdrawal.

According to various embodiments, the retention information on cryptocurrency may include an API key value authorized for deposit and withdrawal with respect to a cryptocurrency wallet.

According to various embodiments, the retention information on cryptocurrency may include a private key value or an API key value for which authority for withdrawal from the cryptocurrency wallet is restricted.

According to various embodiments, the method for charging copyright royalty and allocating profits on the basis of domain-digital asset linkage may further include: obtaining, by the registrar server, certification of payment information from the client of the domain owner or prospective owner; and sending, to one or more of the node servers from the registrar server, a request for remittance of an amount of digital coins corresponding to the certified payment information from a cryptocurrency wallet included in the retention information on cryptocurrency to a cryptocurrency wallet connected to the registrar server.

According to various embodiments, the method for charging copyright royalty and allocating profits on the basis of domain-digital asset linkage may further include: sending, by the registrar server, a request for transmission of a market price value of digital coins to a cryptocurrency transaction intermediary server connected to any one of the node servers; receiving, by the registrar server, the market price value of the digital coins from the cryptocurrency transaction intermediary server; and sending, to the cryptocurrency transaction intermediary server from the registrar server, a request for sale of all or part of a holding amount of the cryptocurrency wallet if a product of the market price value and the holding amount of the cryptocurrency wallet is greater than a predetermined value.

According to various embodiments, the method for charging copyright royalty and allocating profits on the basis of domain-digital asset linkage may further include: receiving, by the registrar server, a request for remittance of digital coins for which transaction is made from the cryptocurrency transaction intermediary server; and sending, to any one of the node servers from the registrar server, a request for remittance of an amount of digital coins requested to be remitted from the cryptocurrency wallet included in the retention information on cryptocurrency to a remittance target cryptocurrency wallet for which remittance is requested.

According to various embodiments, the method for charging copyright royalty and allocating profits on the basis of domain-digital asset linkage may further include storing, by the registrar server, a transaction record of the digital coins requested to be remitted in the database of the registrar server.

According to various embodiments, the retention information on cryptocurrency may be an address value of a cryptocurrency wallet.

According to various embodiments, the method for charging copyright royalty and allocating profits on the basis of domain-digital asset linkage may further include sending, to one or more of the node servers from the registrar server, a request for remittance of a predetermined amount of digital coins from a cryptocurrency wallet connected to the registrar server to a wallet corresponding to an address value of the cryptocurrency wallet.

According to various embodiments, the method for charging copyright royalty and allocating profits on the basis of domain-digital asset linkage may further include sending, by the registrar server, a request for recording of a data pair of the domain address and the retention information on cryptocurrency to one or more of the node servers.

According to various embodiments, the retention information on cryptocurrency may be retention information on at least one type of cryptocurrency.

According to various embodiments, the method for charging copyright royalty and allocating profits on the basis of domain-digital asset linkage may further include: receiving, by the registrar server, an inquiry about domain information from an arbitrary client; and transmitting, by the registrar server, the domain entity including the domain address or digital asset information to the client that has sent the inquiry.

According to various embodiments, the method for charging copyright royalty and allocating profits on the basis of domain-digital asset linkage may further include: transmitting, by the registrar server, copyright coin issuance information to an intermediary core web server; receiving, by the intermediary core web server, supply product information input from a provider through an intermediary core web page; providing, by the intermediary core web server, the supply product information to a seller through the intermediary core web page; receiving, by the intermediary core web server, sale product information input from the seller through the intermediary core web page; and transmitting, by the intermediary core web server, the sale product information to a web server of the seller such that the sale product information is linked to a web page of the seller.

According to various embodiments, the method for charging copyright royalty and allocating profits on the basis of domain-digital asset linkage may further include providing, by the web server of the seller, the web page of the seller including the sale product information to a purchaser as the sale product information is received.

According to various embodiments, the method for charging copyright royalty and allocating profits on the basis of domain-digital asset linkage may further include: receiving, by the web server of the seller, purchase product information through the web page of the seller; and transmitting, by the web server of the seller, the purchase produce information to the intermediary core web server.

According to various embodiments, the method for charging copyright royalty and allocating profits on the basis of domain-digital asset linkage may further include: transmitting, by the intermediary core web server, the received purchase product information to a web server of the provider; and receiving, by the intermediary core web server, delivery information corresponding to the purchase product information.

According to various embodiments, the method for charging copyright royalty and allocating profits on the basis of domain-digital asset linkage may further include transmitting, by the intermediary core web server, the received delivery information to the web server of the seller.

According to various embodiments, the method for charging copyright royalty and allocating profits on the basis of domain-digital asset linkage may further include: calculating: by a payment management server connected to the intermediary core web server, a sale amount on the basis of the purchase product information; calculating, by the payment management server, a settlement amount of the provider on the basis of the copyright coin issuance information, the sale amount, and a deposit of the seller; and providing, by the payment management server, the settlement amount of the provider to at least one right holder of copyright coins.

According to various embodiments, the method for charging copyright royalty and allocating profits on the basis of domain-digital asset linkage may further include: setting, by the payment management server connected to the intermediary core web server, a total amount limit on the basis of the deposit of the seller; comparing, by the payment management server, a total amount of sale products included in the sale product information with the total amount limit; restricting, by the payment management server, supply product selection of the seller if the total amount of the sale products is greater than the total amount limit; and displaying, by the intermediary core web server, a guide message requesting an additional deposit on the intermediary core web page.

According to various embodiments, the method for charging copyright royalty and allocating profits on the basis of domain-digital asset linkage may further include canceling, by the payment management server, restriction on supply product selection when an additional deposit of the seller is confirmed.

According to various embodiments, the method for charging copyright royalty and allocating profits on the basis of domain-digital asset linkage may further include: setting, by the payment management server connected to the intermediary core web server, a reference amount on the basis of the deposit of the seller; comparing, by the payment management server, a current deposit of the seller with the reference amount when the purchase product information of the purchaser is received through the web server of the seller; and restricting, by the payment management server, payment of the purchaser when the current deposit of the seller is less than the reference amount.

According to various embodiments, the method for charging copyright royalty and allocating profits on the basis of domain-digital asset linkage may further include transmitting, by the payment management server, a notification message requesting an additional deposit to the web server of the seller or an electronic device of the seller.

According to various embodiments, the method for charging copyright royalty and allocating profits on the basis of domain-digital asset linkage may further include canceling, by the payment management server, restriction on payment of the purchaser when the additional deposit is confirmed.

According to various embodiments, the method for charging copyright royalty and allocating profits on the basis of domain-digital asset linkage may further include resetting, by the payment management server, the reference amount on the basis of an increased deposit when the amount of the current deposit is greater than an initial deposit due to deposit of the additional deposit.

According to various embodiments of the present disclosure, a system for charging copyright royalty and allocating profits on the basis of domain-digital asset linkage may include a registrar server connected to a registry server, a network having node servers and a blockchain structure in which transaction records of digital coins are encrypted, and a client of a domain owner or a prospective owner, wherein the registrar server receives a request for registration of a domain entity including a domain address and digital asset information from the client of the domain owner or the prospective owner and sends a request for registration of all or part of the domain entity to the registry server, the digital asset information is retention information on cryptocurrency in which transaction records of digital coins are encrypted and connected to the network having node servers and a blockchain structure, and the digital coins include copyright coins issued on the basis of a copyright.

According to various embodiments, the system for charging copyright royalty and allocating profits on the basis of domain-digital asset linkage may further include: a central management server configured to manage supply product and service information received from a provider and sale product information received from a seller; a payment management server configured to manage a deposit of the seller, purchase product information of a purchaser, and a settlement amount of the provider; an intermediary core DB server configured to store the supply product and service information, the sale product information, the purchase product information, the deposit, and the settlement amount as a database; an intermediary core web server configured to provide an intermediate core web page; and a web server of the seller configured to provide a web page of the seller, wherein the intermediary core web server receives copyright coin issuance information from the registrar server, receives supply product and service information input from the provider through the intermediary core web page, provides the supply product and service information to the seller through the intermediary core web page, receives input of the sale product information from the seller through the intermediary core web page, and transmits the sale product information to the web server of the seller such that the sale product information is linked to the web page of the seller.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Accordingly, the scope of the invention should be determined by the appended claims and their legal equivalents, not by the above description, and all changes coming within the meaning and equivalency range of the appended claims are intended to be embraced therein.

### DETAILED DESCRIPTION OF MAIN ELEMENTS

10: system for charging copyright royalty and allocating profits on the basis of domain-digital asset linkage

| | |
|---|---|
| 100: registrar server | 110: database |
| 100: registry server | 210: database |
| 300: network | 310: node |
| 400: client | |
| 500: cryptocurrency transaction | |
| intermediary server | |
| 600, 601, 602, 603: intermediary core | |
| 610, 611, 612, 613: central management | |
| server | |
| 620, 621, 622, 623: payment | |
| management server | |
| 630, 631, 632, 633: artificial | |
| intelligence server | |
| 640, 641, 642, 643: UI server | |
| 650, 651, 652, 653: DB server | 660, 661, 662, 663: web server |
| 700, 703: provider | 701: copyright holder |
| 702: distributor | 704: content creator |
| 710, 711, 712, 714: UI server | 720, 721, 722, 723, 724: DB |
| | server |
| 730, 731, 732, 733, 734: web server | |
| 800, 803, 804: seller | |
| 801: primary seller | 802: secondary seller |
| 810, 811, 812, 814: UI server | |
| 820, 821, 822, 823, 824: DB server | 830, 831, 832, 833, 834: web |
| | server |

### INDUSTRIAL AVAILABILITY

The present disclosure relates to a method and system for charging copyright royalty and allocating profits on the basis of domain-digital asset linkage and can achieve smooth charging of copyright royalty and allocation of profits using linked copyright coin issuance information according to domain-copyright coin linkage, diversify profits of copyright according to issuance of fund type copyright coins, activate distribution of works according to direct transaction of works between an original copyright holder and a seller, increase work related profits of both the original copyright holder and the seller, and be used in fields such as an electronic commerce of works.

1. A method for charging copyright royalty and allocating profits, by a registrar server, on the basis of domain-digital asset linkage, comprising:
receiving, by the registrar server, a request for registration of a domain entity including a domain address and digital asset information from a client of a domain owner or a prospective owner; and
sending, by the registrar server, a request for registration of all or part of the domain entity to a registry server,
wherein the digital asset information is retention information on cryptocurrency in which transaction records of digital coins are encrypted and connected to a network having node servers and a blockchain structure, and
the digital coins include copyright coins issued on the basis of a copyright.

2. The method of claim 1, wherein
the copyright coins include stand-alone copyright coins issued on the basis of an individual work and fund type copyright coins issued on the basis of a plurality of works.

3. The method of claim 1, comprising:
receiving, by the registrar server, a request for issuance of copyright coins from a client of a domain owner or a prospective domain owner; and
sending, by the registrar server, a request for recording of the domain address and issuance of the copyright coins to one or more of the node servers.

4. The method of claim 3, comprising:
allocating, by the registrar server, the issued copyright coins to the client of the domain owner or the prospective domain owner using one or more of the node servers.

5. The method of claim 1, comprising:
receiving, by the registrar server, a request for issuance of copyright coins based on a plurality of works from a client of a domain owner or a prospective domain owner;
checking, by the registrar server, work investment information related to the plurality of works;
issuing, by the registrar server, fund type copyright coins based on some or all of the plurality of works on the basis of the work investment information; and
sending, by the registrar server, a request for recording of the domain address and issuance of the fund type copyright coins to one or more of the node servers.

6. The method of claim 1, further comprising
storing, by the registrar server, all or part of the domain entity in a database of the registrar server.

7. The method of claim 1, wherein the retention information on cryptocurrency includes an asset ID of a cryptocurrency wallet or a private key value authorized for deposit and withdrawal.

8. The method of claim 1, wherein
the retention information on cryptocurrency includes an API key value authorized for deposit and withdrawal with respect to a cryptocurrency wallet.

9. The method of claim 1, wherein the retention information on cryptocurrency include a private key value or an API key value for which authority on withdrawal from a cryptocurrency wallet is restricted.

10. The method of claim 3, further comprising:
obtaining, by the registrar server, certification of payment information from the client of the domain owner or prospective owner; and
sending, to one or more of the node servers from the registrar server, a request for remittance of an amount of digital coins corresponding to the certified payment information from a cryptocurrency wallet included in the retention information on cryptocurrency to a cryptocurrency wallet connected to the registrar server.

11. The method of claim 1, further comprising:
sending, by the registrar server, a request for transmission of a market price value of digital coins to a cryptocurrency transaction intermediary server connected to any one of the node servers;
receiving, by the registrar server, the market price value of the digital coins from the cryptocurrency transaction intermediary server; and
sending, to the cryptocurrency transaction intermediary server from the registrar server, a request for sale of all or part of a holding amount of the cryptocurrency wallet if a product of the market price value and the holding amount of the cryptocurrency wallet is greater than a predetermined value.

12. The method of claim 11, further comprising:
receiving, by the registrar server, a request for remittance of digital coins for which transaction is made from the cryptocurrency transaction intermediary server; and
sending, to any one of the node servers from the registrar server, a request for remittance of an amount of digital coins requested to be remitted from the cryptocurrency wallet included in the retention information on cryptocurrency to a remittance target cryptocurrency wallet for which remittance is requested.

13. The method of claim 12, further comprising
storing, by the registrar server, a transaction record of the digital coins requested to be remitted in the database of the registrar server.

14. The method of claim 1, wherein
the retention information on cryptocurrency is an address value of a cryptocurrency wallet.

15. The method of claim 1, further comprising
sending, to one or more of the node servers from the registrar server, a request for remittance of a predetermined amount of digital coins from the cryptocurrency wallet connected to the registrar server to a wallet corresponding to an address value of the cryptocurrency wallet.

16. The method of claim 1, further comprising
sending, by the registrar server, a request for recording of a data pair of the domain address and the retention information on cryptocurrency to one or more of the node servers.

17. The method of claim 1, wherein the retention information on cryptocurrency is retention information on at least one type of cryptocurrency.

18. The method of claim 1, further comprising:
receiving, by the registrar server, an inquiry about domain information from an arbitrary client; and
transmitting, by the registrar server, the domain entity including the domain address or digital asset information to the client that has sent the inquiry.

19. The method of claim 1, further comprising:
transmitting, by the registrar server, copyright coin issuance information to an intermediary core web server;
receiving, by the intermediary core web server, supply product information input from a provider through an intermediary core web page;
providing, by the intermediary core web server, the supply product information to a seller through the intermediary core web page;
receiving, by the intermediary core web server, sale product information input from the seller through the intermediary core web page; and
transmitting, by the intermediary core web server, the sale product information to a web server of the seller such that the sale product information is linked to a web page of the seller.

20. The method of claim 19, further comprising
providing, by the web server of the seller, the web page of the seller including the sale product information to a purchaser as the sale product information is received.

21. The method of claim 20, further comprising:
receiving, by the web server of the seller, purchase product information through the web page of the seller; and
transmitting, by the web server of the seller, the purchase produce information to the intermediary core web server.

22. The method of claim 21, further comprising:
transmitting, by the intermediary core web server, the received purchase product information to a web server of the provider; and
receiving, by the intermediary core web server, delivery information corresponding to the purchase product information from the web server of the provider.

23. The method of claim 22, further comprising
transmitting, by the intermediary core web server, the received delivery information to the web server of the seller.

24. The method of claim 23, further comprising:
calculating, by a payment management server connected to the intermediary core web server, a sale amount on the basis of the purchase product information;
calculating, by the payment management server, a settlement amount of the provider on the basis of the copyright coin issuance information, the sale amount, and a deposit of the seller; and
providing, by the payment management server, the settlement amount of the provider to at least one right holder of copyright coins.

25. The method of claim 24, further comprising:
setting, by the payment management server connected to the intermediary core web server, a total amount limit on the basis of the deposit of the seller;
comparing, by the payment management server, a total amount of sale products included in the sale product information with the total amount limit;
restricting, by the payment management server, supply product selection of the seller if the total amount of the sale products is greater than the total amount limit; and
displaying, by the intermediary core web server, a guide message requesting an additional deposit on the intermediary core web page.

26. The method of claim 25, further comprising
canceling, by the payment management server, restriction on supply product selection when an additional deposit of the seller is confirmed.

27. The method of claim 19, further comprising:
setting, by the payment management server connected to the intermediary core web server, a reference amount on the basis of the deposit of the seller;
comparing, by the payment management server, a current deposit of the seller with the reference amount when the purchase product information of the purchaser is received through the web server of the seller; and
restricting, by the payment management server, payment of the purchaser when the current deposit of the seller is less than the reference amount.

28. The method of claim 27, further comprising
transmitting, by the payment management server, a notification message requesting an additional deposit to the web server of the seller or an electronic device of the seller.

29. The method of claim 28, further comprising
canceling, by the payment management server, restriction on payment of the purchaser when the additional deposit is confirmed.

30. The method of claim 29, further comprising
resetting, by the payment management server, the reference amount on the basis of an increased deposit when the amount of the current deposit is greater than an initial deposit due to deposit of the additional deposit.

31. A system for charging copyright royalty and allocating profits on the basis of domain-digital asset linkage, comprising
a registrar server connected to a registry server, a network having node servers and a blockchain structure in which transaction records of digital coins are encrypted, and a client of a domain owner or a prospective owner,
wherein the registrar server receives a request for registration of a domain entity including a domain address and digital asset information from the client of the domain owner or the prospective owner and sends a request for registration of all or part of the domain entity to the registry server,
the digital asset information is retention information on cryptocurrency in which transaction records of digital coins are encrypted and connected to the network having node servers and a blockchain structure, and
the digital coins include copyright coins issued on the basis of a copyright.

32. The system of claim 31, further comprising:
a central management server configured to manage supply product and service information received from a provider and sale product information received from a seller;
a payment management server configured to manage a deposit of the seller, purchase product information of a purchaser, and a settlement amount of the provider;
an intermediary core DB server configured to store the supply product and service information, the sale product information, the purchase product information, the deposit, and the settlement amount as a database;
an intermediary core web server configured to provide an intermediate core web page; and
a web server of the seller configured to provide a web page of the seller,
wherein the intermediary core web server is configured to
receive copyright coin issuance information from the registrar server,
receive supply product and service information input from the provider through the intermediary core web page,
provide the supply product and service information to the seller through the intermediary core web page,
receive input of the sale product information from the seller through the intermediary core web page, and
transmit the sale product information to the web server of the seller such that the sale product information is linked to the web page of the seller.
